(19) United States
(12) Patent Application Publication
(10) Pub. No.: US 2010/0261419 A1
(43) Pub. Date: Oct. 14, 2010

(54) Superabrasive Tool Having Surface Modified Superabrasive Particles and Associated Methods

(76) Inventor: Chien-Min Sung, Tansui (TW)

Correspondence Address: THORPE NORTH & WESTERN, LLP., P.O. Box 1219, SANDY, UT, 84091-1219, US

(21) Appl. No.: 12/710,818

(22) Filed: Feb. 23, 2010

Related U.S. Application Data
(60) Provisional application No. 61/168,479, filed on Apr. 10, 2009.

(51) Int. Cl. B24B 53/00; C09K 3/14; B24D 3/00

(52) U.S. Cl. 451/443; 51/307

(57) ABSTRACT

Superabrasive tools and associated methods of making and using are provided. In one aspect, for example, a superabrasive tool having improved superabrasive particle retention is provided. Such a tool can include a matrix layer and a plurality of superabrasive particles held in and protruding from the matrix layer, whereby surfaces of the plurality of superabrasive particles contacting the matrix layer have been roughened to have an RA of greater than about 1 micron, and wherein the roughened surfaces improve the retention of the plurality of superabrasive particles in the matrix layer.

### PRIORITY DATA

This application claims the benefit of U.S. Provisional Patent Application Ser. No. 61/168,479, filed on Apr. 10, 2009 which is incorporated herein by reference.

### FIELD OF THE INVENTION

The present invention relates generally to a device and methods for abrading a work piece. Accordingly, the present invention involves the chemical and material science fields.

### BACKGROUND OF THE INVENTION

Many industries utilize abrading tools such as chemical mechanical polishing (CMP) devices for polishing certain work pieces. Particularly, the computer manufacturing industry relies heavily on CMP processes for polishing wafers of ceramics, silicon, glass, quartz, and metals. Such polishing processes generally entail applying the wafer against a rotating pad made from a durable organic substance such as polyurethane. A chemical slurry is utilized that contains a chemical capable of breaking down the wafer substance and an amount of abrasive particles which act to physically erode the wafer surface. The slurry is continually added to the rotating CMP pad, and the dual chemical and mechanical forces exerted on the wafer cause it to be polished in a desired manner.

Of particular importance to the quality of polishing achieved is the distribution of the abrasive particles throughout the pad. The top of the pad holds the particles by means of fibers or small pores, which provide a friction force sufficient to prevent the particles from being thrown off of the pad due to the centrifugal force exerted by the pad's spinning motion. Therefore, it is important to keep the top of the pad as flexible as possible, to keep the fibers as erect as possible, and to assure that there is an abundance of open pores available to receive newly applied abrasive particles.

One problem that arises with regard to maintaining the pad surface, however, is an accumulation of polishing debris coming from the work piece, the abrasive slurry, and the pad dresser. This accumulation causes a “glazing” or hardening of the top of the pad, mats the fibers down, and thus makes the pad surface less able to hold the abrasive particles of the slurry. These effects significantly decrease the pad's overall polishing performance. Further, with many pads, the pores used to hold the slurry, become clogged, and the overall asperity of the pad's polishing surface becomes depressed and matted. A CMP pad dresser can be used to revive the pad surface by “combing” or “cutting” it. This process is known as “dressing” or “conditioning” the CMP pad. Many types of devices and processes have been used for this purpose. One such device is a disk with a plurality of superhard crystalline particles such as diamond particles attached to a metal-matrix surface.

Ultra-large-scale integration (ULSI) is a technology that places at least 1 million circuit elements on a single semiconductor chip. In addition to the tremendous density issues that already exist, with the current movement toward size reduction, ULSI has become even more delicate, both in size and materials than ever before. Therefore, the CMP industry has been required to respond by providing polishing materials and techniques that accommodate these advances. For example, lower CMP polishing pressures, smaller size abrasive particles in the slurry, and polishing pads of a size and nature that do not over polish the wafer must be used. Furthermore, pad dressers that cut asperities in the pad which can accommodate the smaller abrasive particles, and that do not overdress the pad must be used.

There are a number of problems in attempting to provide such a pad dresser. First, the superabrasive particles must be significantly smaller than those typically used in currently know dressing operations. Generally speaking, the superabrasive particles are so small that a traditional metal matrix is often unsuitable for holding and retaining them. Further, the smaller size of the superabrasive particles, means that the particle tip height must be precisely leveled in order to uniformly dress the pad. Traditional CMP pad dressers can have particle tip height variations of more than 50 μm without compromising dressing performance. However, such a variation would render a dresser useless if it were required to dress a CMP pad and achieve a uniform asperity depth of 20 μm or less, for example.

In addition to issues with properly holding very small superabrasive particles, the tendencies of metal to warp and buckle during a heating process, cause additional issues in obtaining a CMP pad dresser having superabrasive particle tips leveled to within a narrow tolerance range. While other substrate materials such as polymeric resins have been know, such materials typically are not able to retain superabrasive particles to a degree that is sufficient for CMP pad dressing.

As a result, a CMP pad dresser that is suitable for dressing a CMP pad that meet the demands placed upon the CMP industry by the continual reductions in semiconductor size is still being sought.

### SUMMARY OF THE INVENTION

Accordingly, the present invention provides superabrasive tools and associated methods of making and use. In one aspect, for example, a superabrasive tool having improved superabrasive particle retention is provided. Such a tool can include a matrix layer and a plurality of superabrasive particles held in and protruding from the matrix layer, whereby surfaces of the plurality of superabrasive particles contacting the matrix layer have been roughened to have an RA of greater than about 1 micron. In some aspects, the roughened surfaces improve the retention of the plurality of superabrasive particles in the matrix layer. In another aspect, the roughened surfaces of the plurality of diamond particles have an RA of from about 2 microns to about 10 microns.

A variety of matrix layers can be utilized to hold the plurality of superabrasive particles. In one aspect, for example, the matrix layer is a resin layer. A variety of resin layers are contemplated, non-limiting examples of which include amino resins, acrylate resins, alkyd resins, polyester resins, reactive urethane resins, phenolic resins, phenolic/latex resins, epoxy resins, isocyanate resins, isocyanurate resins, polysiloxane resins, reactive vinyl resins, polyethylene resins, polypropylene resins, polystyrene resins, phenoxy resins, perylene resins, polysulfone resins, acrylonitrile-butadiene-styrene resins, acrylic resins, polycarbonate resins, polyimide resins, and mixtures thereof. In one specific aspect, the resin layer is an epoxy resin. In another specific aspect, the resin layer is a polycarbonate resin. In yet another specific aspect, the resin layer is a polyimide resin.

Various superabrasive materials are contemplated for use in the present invention. In one aspect, for example, the plurality of superabrasive particles can include a material such as diamond, cubic boron nitride, and combinations thereof. In one specific aspect, the plurality of superabrasive particles can be diamond.

The present invention additionally provides methods of making superabrasive tools. In one aspect, for example, a method of making a superabrasive tool having improved superabrasive particle retention is provided. Such a method can include roughening surfaces of a plurality of superabrasive particles to an RA of greater than about 1 micron, disposing the plurality of superabrasive particles in a matrix precursor, and solidifying the matrix precursor into a matrix layer such that the plurality of superabrasive particles are held in and protrude from the matrix layer, whereby the roughened surfaces of the plurality of superabrasive particles improves retention of the plurality of superabrasive particles in the matrix layer as compared to retention of a superabrasive particle prior to roughening.

Any technique of roughening a superabrasive particle surface should be considered to be within the scope of the present invention. In one aspect, for example, roughening the surfaces can include oxidizing the surfaces. In another aspect, roughening the surfaces can include includes etching the surfaces. In the case of diamond superabrasive particles, in one aspect roughening the surfaces can include depositing diamond material on surfaces of the plurality of superabrasive particles.

Additionally, various superabrasive materials are contemplated for use in the devices and methods according to aspects of the present invention. In one aspect, for example, the plurality of superabrasive particles can include diamond, cubic boron nitride, and combinations thereof. In another aspect, the plurality of superabrasive particles can include diamond.

Furthermore, it is contemplated that various “reverse casting” methods can be utilized in the manufacture of superabrasive devices according to aspects of the present invention. In one aspect, for example, disposing the plurality of superabrasive particles in the matrix precursor and solidifying the matrix precursor into the matrix layer further includes providing a temporary substrate having a working surface, applying a spacer layer to the working surface of the temporary substrate, and disposing the plurality of superabrasive particles at least partially into the spacer layer so that the plurality of superabrasive particles protrude at least partially from the spacer layer opposite the working surface of the temporary substrate. The method can additionally include applying the matrix precursor to the spacer layer opposite the working surface of the temporary substrate, solidifying the matrix precursor into the matrix layer, removing the temporary substrate from the spacer layer, and removing the spacer layer from the matrix layer.

Additionally, various techniques of applying the spacer layer are contemplated. In one aspect, for example, applying a spacer layer can include applying the spacer layer to the working surface of the temporary substrate and pressing the plurality of superabrasive particles into the spacer layer. In another aspect, applying a spacer layer can include disposing the plurality of superabrasive particles along the working surface of the temporary substrate, and pressing the spacer layer onto the plurality of superabrasive particles such that the superabrasive particles are disposed at least partially within the spacer layer.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a cross-section view of a superabrasive particle embedded in a matrix layer in accordance with one embodiment of the present invention.

FIG. 2 is a cross-sectional view of superabrasive particles disposed on a temporary substrate in accordance with one embodiment of the present invention.

FIG. 3 is a cross-sectional view of superabrasive particles disposed on a temporary substrate in accordance with one embodiment of the present invention.

FIG. 4 is a cross-sectional view of superabrasive particles disposed on a temporary substrate in accordance with one embodiment of the present invention.

FIG. 5 is a cross-sectional view superabrasive particles disposed in a resin layer in accordance with one embodiment of the present invention.

FIG. 6 is a collection of SEM micrographs of diamond particles showing surface roughening in accordance with one embodiment of the present invention.

FIG. 7 is a collection of SEM micrographs of diamond particles showing surface roughening in accordance with one embodiment of the present invention.

FIG. 8 is a collection of SEM micrographs of diamond particles showing surface roughening in accordance with one embodiment of the present invention.

### DETAILED DESCRIPTION OF THE INVENTION

Definitions

In describing and claiming the present invention, the following terminology will be used in accordance with the definitions set forth below.

The singular forms “a,” “an,” and, “the” include plural referents unless the context clearly dictates otherwise. Thus, for example, reference to “a particle” includes reference to one or more of such particles, and reference to “the resin” includes reference to one or more of such resins.

As used herein, “resin” refers to a semisolid or solid complex amorphous mix of organic compounds. As such, “resin layer” refers to a layer of a semisolid or solid complex amorphous mix of organic compounds. In one aspect, the resin will be a polymer or copolymer formed from the polymerization of one or more monomers.

As used herein, “superhard” and “superabrasive” may be used interchangeably, and refer to a crystalline, or polycrystalline material, or mixture of such materials having a Vicker's hardness of about 4000 Kg/mm² or greater. Such materials may include without limitation, diamond, and cubic boron nitride (cBN), as well as other materials known to those skilled in the art. While superabrasive materials are very inert and thus difficult to form chemical bonds with, it is known that certain reactive elements, such as chromium and titanium are capable of chemically reacting with superabrasive materials at certain temperatures.

As used herein, “particle,” when used in connection with a superabrasive material, refers to a particulate form of such material. Such particles may take a variety of shapes, including round, oblong, square, euhedral, etc., as well as a number of specific mesh sizes. As is known in the art, “mesh” refers to the number of holes per unit area as in the case of U.S. meshes.

As used herein, “Ra” refers to a measure of the roughness of a surface as determined by the difference in height between a peak and a neighboring valley. Further, “Rmax” is a measure of surface roughness as determined by the difference in height between the highest peak on the surface and the lowest valley on the surface. As used herein, “euhedral” means idiomorphic, or having an unaltered natural shape containing natural crystallographic faces.

As used herein, “substrate” means a portion of a CMP dresser which supports abrasive particles, and to which abrasive particles may be affixed. Substrates useful in the present invention may be any shape, thickness, or material, that is capable of supporting abrasive particles in a manner that is sufficient provide a tool useful for its intended purpose. Substrates may be of a solid material, a powdered material that becomes solid when processed, or a flexible material. Examples of typical substrate materials include without limitation, metals, metal alloys, ceramics, polymers, and mixtures thereof.

As used herein, “metallic” refers to a metal, or an alloy of two or more metals. A wide variety of metallic materials is known to those skilled in the art, such as aluminum, copper, chromium, iron, steel, stainless steel, titanium, tungsten, zinc, zirconium, molybdenum, etc., including alloys and compounds thereof.

As used herein, “ceramic” refers to a hard, often crystalline, substantially heat and corrosion resistant material which may be made by firing a non-metallic material, sometimes with a metallic material. A number of oxide, nitride, and carbide materials considered to be ceramic are well known in the art, including without limitation, aluminum oxides, silicon oxides, boron nitrides, silicon nitrides, and silicon carbides, tungsten carbides, etc.

As used herein, “mechanical bond” and “mechanical bonding” may be used interchangeably, and refer to a bond interface between two objects or layers formed primarily by frictional forces. In some cases the frictional forces between the bonded objects may be increased by expanding the contacting surface areas between the objects, and by imposing other specific geometrical and physical configurations, such as substantially surrounding one object with another.

As used herein, “amorphous braze” refers to a homogenous braze composition having a non-crystalline structure. Such alloys contain substantially no eutectic phases that melt incongruently when heated. Although precise alloy composition is difficult to ensure, the amorphous brazing alloy as used herein should exhibit a substantially congruent melting behavior over a narrow temperature range.

As used herein, “alloy” refers to a solid or liquid mixture of a metal with a second material, said second material may be a non-metal, such as carbon, a metal, or an alloy which enhances or improves the properties of the metal.

As used herein, “braze alloy” and “brazing alloy” may be used interchangeably, and refer to a metal alloy which is capable of chemically bonding to superabrasive particles, and to a matrix support material, or substrate, so as to substantially bind the two together. The particular braze alloy components and compositions disclosed herein are not limited to the particular embodiment disclosed in conjunction therewith, but may be used in any of the embodiments of the present invention disclosed herein. In one aspect, “braze alloy” can refer to an alloy containing a sufficient amount of a reactive element to allow the formation of chemical bonds between the alloy and a superabrasive particle.

The alloy may be either a solid or liquid solution of a metal carrier solvent having a reactive element solute therein.

As used herein, the process of “brazing” is intended to refer to the creation of chemical bonds between the carbon atoms of the superabrasive particles and the braze material. Further, “chemical bond” means a covalent bond, such as a carbide or boride bond, rather than mechanical or weaker inter-atom attractive forces. Thus, when “brazing” is used in connection with superabrasive particles a true chemical bond is being formed. However, when “brazing” is used in connection with metal to metal bonding the term is used in the more traditional sense of a metallurgical bond. Therefore, brazing of a tool precursor to a tool body does not require the presence of a carbide former.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The Invention

The present invention provides superabrasive tools including methods for their use and manufacture. The manufacture and use of superabrasive tools can be problematic in some cases due to poor retention of superabrasive particles in the tool matrix, as well as difficulties inherent in working with materials at the high temperatures that are often required to make such tools. The inventor has found that the retention of a superabrasive particle in a matrix layer can be improved by roughening at least one surface of the superabrasive particle that contacts the matrix layer. The more surface area that is roughened, the greater is the retention of the superabrasive particle in the matrix. As such, in one aspect, all areas of the superabrasive particle that contact the matrix layer can be roughened. Additionally, in other aspects this improved retention allows materials to be used in making such tools that are otherwise avoided due to high temperatures.

It should be noted that roughening the surface of a superabrasive particle can have benefits beyond retention. For example, such a roughened surface can improve the cutting action of the tool on the work piece. In the case of CMP pad dressers, rough superabrasive particles tend to cut the pad more effectively rather than deforming the pad around the superabrasive particles is sometimes the case with smooth diamond tips. These roughened superabrasive particles have small protrusions that can be more effective in cutting the soft CMP pads. Thus the dressing rate of the CMP pad is increased with the increase of the surface area of the superabrasive particles.

In one aspect of the present invention, a superabrasive tool having improved superabrasive particle retention is provided. Such a tool can include a matrix layer and a plurality of superabrasive particles held in and protruding from the matrix layer. Surfaces of the plurality of superabrasive particles contacting the matrix layer are roughened to have an RA of greater than about 1 micron. These roughened surfaces improve the retention of the plurality of superabrasive particles in the matrix layer. It is important to note, that the term “superabrasive tool” also refers not only to functional superabrasive tools, but also to tool precursors that are subsequently coupled to a support structure to form a functional superabrasive tool.

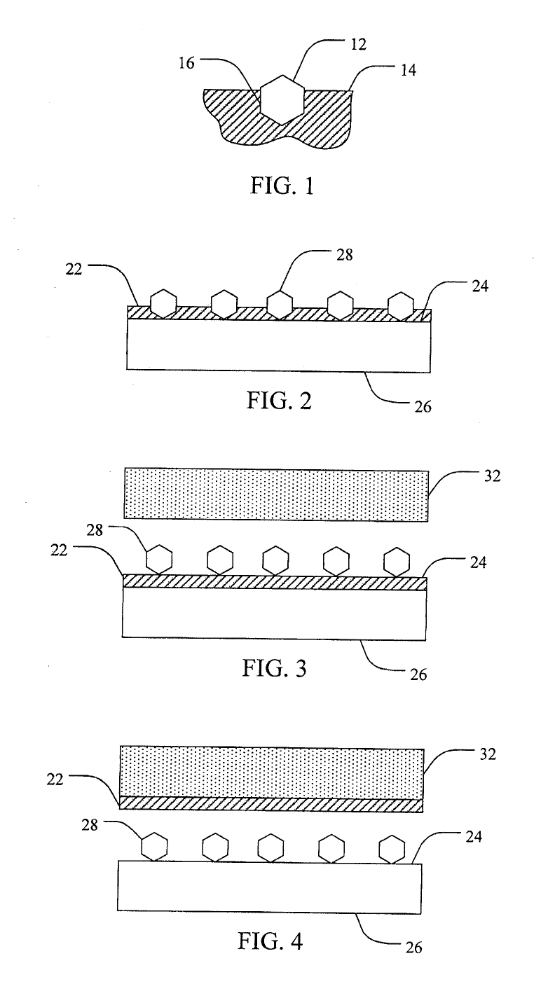

FIG. 1 shows a superabrasive particle 12 embedded in a matrix layer 14. The superabrasive particle 12 has at least one roughened surface 16 that is in contact with the matrix layer 14. Thus the roughened surface(s) 16 can provide improved mechanical bonding with the matrix layer 14 as compared to the relatively smooth and inert surface of a superabrasive material without such roughening.

Various superabrasive materials are well known in the art, and it is to be understood that the present scope includes all such materials. Examples of a few of such materials include natural and synthetic diamond, cubic boron nitride, silicon carbide, and the like. In one specific aspect, the plurality of superabrasive particles includes diamond. Additionally, superabrasive particles can have a variety of shapes. Non-limiting examples of possible shapes include euhedral, octahedral, cubo-octaheral, cubic, and the like. In one aspect, the superabrasive particles can be single crystal superabrasive particles.

As has been described, roughening of at least a portion of each of the plurality of superabrasive particles can improve retention. Any number of faces or any amount of surface area of a superabrasive particle can be roughened. In one aspect, for example, at least one face of the superabrasive particle is roughened. In another aspect, all of the faces of a superabrasive particle are roughened. In yet another aspect, at least those faces of a superabrasive particle that contact the matrix layer are roughened. In a further aspect, at least substantially all of the surface area of a superabrasive particle that contacts the matrix layer is roughened.

The degree of roughening of the superabrasive particle surface is variable, in many cases depending on the specific superabrasive material and the technique used to roughen that material. In one aspect, however, the superabrasive surface can be roughened to an RA of greater than about 1 micron. In another aspect, the superabrasive surface can be roughened to an RA of from about 2 microns to about 10 microns.

Various techniques are contemplated to effectively roughen a superabrasive particle, including techniques that oxidize, etch, or add superabrasive material to the surface of the superabrasive particles. Numerous oxidation techniques are possible, and it should be understood that any oxidation technique capable of roughening superabrasive material should be considered to be within the present scope. In one aspect, for example, the superabrasive particle surface can be roughened by heating the superabrasive particle in air. One potential drawback for this technique would be the high temperatures (e.g. 900° C.) required to oxidize a superabrasive, such as diamond, in the air. At such high temperatures, metal catalyst that may be present in inclusions within the diamond can cause diamond to be back-converted into graphite, thus potentially causing microcracks that weaken the crystalline structure. Oxidizing the superabrasive particle in an atmosphere that has a high oxygen pressure can allow the oxidation of the superabrasive surface to occur at lower temperatures, thus avoiding potential weakening of the crystal lattice. The superabrasive particle can be oxidized in other gaseous or liquid agents such as water steam, ozone, plasma, carbon monoxide, molten salt of potassium nitrate, hydroxides, permanganates, etc., in order to reduce the oxidation temperature of the reaction.

In another aspect, etching techniques can be used to roughen the superabrasive particle surfaces. For example, diamond can be etched using a catalyst under high pressure to convert areas of the diamond surface into graphite, and thus sufficiently roughening the surface. Non-limiting examples of suitable catalysts include Fe, Ni, Co, Mn, and the like.

In yet another aspect, a superabrasive particle can be roughened through the addition of a crystalline material to the superabrasive surface. In the case of diamond superabrasive particles, for example, carbon atoms can be deposited on the surface to form roughened “bumps,” thus sufficiently increasing the RA of the surface. In one specific aspect, diamond can be CVD deposited by thermal decomposition of methane diluted in hydrogen. Such deposition can form diamond homoepitaxially on the superabrasive surface that is thus strongly bonded thereto. Not only will this deposited diamond assist in retention of the superabrasive particle in the matrix layer, but the rough deposited diamond will also assist in the abrading of the work piece.

Numerous matrix materials are known that can be used as a matrix layer to hold the plurality of superabrasive particles for an abrading operation. In some aspects a matrix layer can be the primary support layer for the superabrasive particles. In other aspects a matrix layer can be utilized to bond the superabrasive particles to a support substrate that functions as the primary support structure for the tool. In either case, the matrix material can be any metal matrix or nonmetal matrix capable of retaining a roughened superabrasive particle. In some aspects retention may also be improved by arranging the superabrasive grit according to a predetermined pattern. Such arrangements may apportion to each superabrasive particle a sufficient amount of matrix material to improve retention.

In one aspect, the matrix layer can be a metal matrix. Such a metal matrix can be provided as a braze alloy for bonding the superabrasive particles together and/or to a support substrate. The brazing alloy may be provided as a thin sheet, powder, or continuous sheet of amorphous braze alloy. Various techniques of utilizing braze alloys are known. In one aspect, for example, a brazing alloy powder can first be mixed with a suitable binder (typically organic) and a solvent that can dissolve the binder. This mixture is then blended to form a slurry or dough with a proper viscosity. In order to prevent the powder from agglomeration during the processing, a suitable wetting agent (e.g., menhaden oil, phosphate ester) may also be added. The slurry may then be sprayed or otherwise applied to the support substrate and/or superabrasive particles. In another aspect, the slurry can be poured onto a plastic tape and pulled underneath a blade or leveling device. By adjusting the gap between the blade and the tape, the slurry can be cast into a plate with the desired thickness. The tape casting method is a well-known method for making thin sheets out of powdered materials and works well with the methods according to aspects of the present invention.

The brazing alloy may also be provided as a sheet of amorphous brazing alloy. The sheet of amorphous brazing alloy may be flexible or rigid and may be shaped based on the desired tool contours. This sheet of brazing alloy also aids in the even distribution of the braze material over the surface of the tool. The sheet of brazing alloy contains no powder or binder, but rather is simply a homogenous braze material composition. Amorphous brazing alloys have been found to be advantageous for use in the present invention, as they contain substantially no eutectic phases that melt incongruently when heated. Although precise alloy composition is difficult to ensure, the amorphous brazing alloy often exhibit a substantially congruent melting behavior over a relatively narrow temperature range. Thus, during the heating portion of the brazing process, the alloy does not form grains or a crystalline phase in substantial quantities, i.e. via vitrefication. Further, the melting behavior of the amorphous braze alloy is distinct from sintering, which requires the reduction or elimination of voids between particles of alloy material that does not exist in the amorphous form of the alloy. However, the originally amorphous braze may form non-homogeneous phases during crystallization via the slower cooling process. Generally, amorphous alloys are formed by quickly quenching the liquid into a solid to avoid localized crystallization and variations in composition. Notably, in each of the processes recited herein, the brazing alloy may be presented as a sheet, a film, or a punched out layer that corresponds to the desired tool segment shape.

In another aspect, a powdered brazing alloy can be mixed with a suitable binder and a solvent to form a deformable cake. The cake can then be extruded through a die with a slit opening. The gap in the opening determines the thickness of the extruded plate. Alternatively, the material can also be drawn between two rollers with adjustable gap to form sheets with the right thickness. In another aspect, the braze powder may be showered directly onto diamond particles and substrate.

It may be desirable to make the sheets pliable for subsequent treatments (e.g., bending over the tool substrate). Therefore, a suitable organic plasticizer can also be added to provide the desired characteristics.

The use of organic agents for powder (metal, plastics, or ceramics) processing is well known to those skilled in the art. Typical binders include polyvinyl alcohol (PVA), polyvinyl butyral (PVB), polyethylene glycol (PEG), paraffin, phenolic resin, wax emulsions, and acrylic resins. Typical binder solvents include methanol, ethanol, acetone, trichlorethylene, toluene, etc. Typical plasticizers are polyethylene glycol, diethyl oxalate, triethylene glycol dihydroabietate, glycerin, octyl phthalate. The organic agents so introduced are to facilitate the fabrication of metal layers. Such organic agents should be removed before the consolidation of the metal powders. The binder removal process (e.g., by heating in a furnace with atmospheric control) is also well known to those skilled in the art.

In one aspect, the brazing alloy may be substantially free of zinc, lead, and tin. One commercially available powdered braze alloy, which is suitable for use with the present invention, is known by the trade name NICROBRAZ LM (7 wt % chromium, 3.1 wt % boron, 4.5 wt % silicon, 3.0 wt % iron, a maximum of 0.06 wt % carbon, and balance nickel), made by Wall Colmonoy Company, Madison Heights, Mich. Other suitable alloys included copper, aluminum, and nickel alloys containing chromium, manganese, titanium, and silicon. In one aspect, the brazing alloy may include chromium. In another aspect, the brazing alloy may include a mixture of copper and manganese. In an additional aspect, the amount of chromium, manganese, and silicon may be at least about 5 percent by weight. In another aspect, the alloy may include a mixture of copper and silicon. In yet another aspect, the alloy may include a mixture of aluminum and silicon. In a further aspect, the alloy may include a mixture of nickel and silicon. In another aspect, the alloy may include a mixture of copper and titanium.

In one aspect, the braze material contains at least 3% by weight of a carbide forming member selected from the group consisting of chromium, manganese, silicon, titanium, and aluminum, and alloys and mixtures thereof. Additionally, the braze material can have a liquidus temperature of less than 1,100° C. to avoid damage to the diamond during the brazing process. One commercially available sheet of amorphous brazing alloy which melts at a sufficiently low temperature is an amorphous brazing alloy foil (MBF) manufactured by Honeywell having the NICROBRAZ LM composition.These foil sheets are about 0.001″ thickness and typically melt at between about 1,010° C. and about 1,013° C.

In one aspect, the brazing process may be carried out in a controlled atmosphere, such as under a vacuum, typically about 10⁻⁵ torr, an inert atmosphere (e.g., argon (Ar) or nitrogen (N₂)), or a reducing atmosphere (e.g., hydrogen (H₂)). Such atmospheres may increase the infiltration of the brazing alloy into the matrix support material, and therefore, enhance the diamond-braze and matrix-braze bonding.

The matrix layers of the present invention can also include nonmetal materials. In one aspect, for example, the matrix layer is a resin layer. Numerous resin materials are known to those skilled in the art that would be useful when utilized in embodiments of the present invention. The resin layer can be any curable resin material or resin with sufficient strength to retain the roughened superabrasive particles of the present invention. It may be beneficial to use a resin layer that is relatively hard, and that maintains a flat surface with little or no warping. This allows the superabrasive tool to incorporate very small superabrasive particles at least partially therein, and to maintain these small superabrasive particles at relatively level and consistent heights.

Methods of curing can be any process known to one skilled in the art that causes a phase transition in the resin material from at least a pliable state to at least a rigid state. Curing can occur, without limitation, by exposing the resin material to energy in the form of heat, electromagnetic radiation, such as ultraviolet, infrared, and microwave radiation, particle bombardment, such as an electron beam, organic catalysts, inorganic catalysts, or any other curing method known to one skilled in the art. In one aspect of the present invention, the resin layer may be a thermoplastic material. Thermoplastic materials can be reversibly hardened and softened by cooling and heating respectively. In another aspect, the resin layer may be a thermosetting material. Thermosetting materials cannot be reversibly hardened and softened as with the thermoplastic materials. In other words, once curing has occurred, the process is essentially irreversible.

Resin materials that may be useful in embodiments of the present invention include, but are not limited to: amino resins including alkylated urea-formaldehyde resins, melamine-formaldehyde resins, and alkylated benzoguanamine-formaldehyde resins; acrylate resins including vinyl acrylates, acrylated epoxies, acrylated urethanes, acrylated polyesters, acrylated acrylics, acrylated polyethers, vinyl ethers, acrylated oils, acrylated silicons, and associated methacrylates; alkyd resins such as urethane alkyd resins; polyester resins; reactive urethane resins; phenolic resins such as resole and novolac resins; phenolic/latex resins; epoxy resins such as bisphenol epoxy resins; isocyanate resins; isocyanurate resins; polysiloxane resins including alkylalkoxysilane resins; reactive vinyl resins; resins marketed under the Bakelite trade name, including polyethylene resins, polypropylene resins, epoxy resins, phenolic resins, polystyrene resins, phenoxy resins, perylene resins, polysulfone resins, ethylene copolymer resins, acrylonitrile-butadiene-styrene (ABS) resins, acrylic resins, and vinyl resins; acrylic resins; polycarbonate resins; and mixtures and combinations thereof. In one aspect of the present invention, the resin may be an epoxy resin. In another aspect, the resin material may be a polyimide resin. In yet another aspect, the resin material may be a polycarbonate resin. In yet another aspect, the resin material may be a polyurethane resin.

Numerous additives may be included in the resin material to facilitate its use. For example, additional crosslinking agents and fillers may be used to improve the cured characteristics of the resin layer. Additionally, solvents may be utilized to alter the characteristics of the resin material in the uncured state.

Numerous uses of aspects of the present invention will be apparent to one skilled in the art in possession of the present disclosure. Superabrasive particles can be arranged into tools of various shapes and sizes, including one-, two-, and three-dimensional tools. Tools may incorporate a single layer or multiple layers of superabrasive particles. One example of a tool incorporating a single layer of superabrasive particles in a resin matrix is a CMP pad dresser.

The present invention additionally provides methods for making a superabrasive tool having improved superabrasive particle retention. In one aspect, for example, such a method can include roughening surfaces of a plurality of superabrasive particles to an RA of greater than about 1 micron, disposing the plurality of superabrasive particles in a matrix precursor, and solidifying the matrix precursor into a matrix layer such that the plurality of superabrasive particles are held in and protrude from the matrix layer, whereby the roughened surfaces of the plurality of superabrasive particles improves retention of the plurality of superabrasive particles in the matrix layer as compared to retention of a superabrasive particle prior to roughening.

In some aspects, superabrasive particles can be disposed in the matrix according to a predetermined pattern. Disposing superabrasive particles according to a predetermined pattern may be accomplished by applying spots of glue to a substrate, by creating indentations in the substrate to receive the particles, or by any other means known to one skilled in the art. Additional methods may be found in U.S. Pat. Nos. 6,039,641 and 5,380,390, which are incorporated herein by reference.

Additionally, various reverse casting methods may be utilized to manufacture a CMP pad dresser having a resin matrix. As shown in FIG. 2, a spacer layer 22 may be applied to a working surface 24 of a temporary substrate 26. The spacer layer has superabrasive particles 28 at least partially disposed therein, which protrude at least partially from the spacer layer opposite the working surface of the temporary substrate. Any method of disposing superabrasive particles into a spacer layer such that the superabrasive particles protrude to a predetermined height may be utilized in the present invention. In one aspect, as shown in FIG. 3, the spacer layer 22 is disposed on the working surface 24 of the temporary substrate 26. A fixative may be optionally applied to the working surface to facilitate the attachment of the spacer layer to the temporary substrate. Superabrasive particles 28 are disposed along one side of the spacer layer opposite to the working surface. A fixative may be optionally applied to the spacer layer to hold the superabrasive particles essentially immobile along the spacer layer. The fixative used on either surface of the spacer layer may be any adhesive known to one skilled in the art, such as, without limitation, a polyvinyl alcohol (PVA), a polyvinyl butyral (PVB), a polyethylene glycol (PEG), a pariffin, a phenolic resin, a wax emulsion, an acrylic resin, or combinations thereof. In one aspect, the fixative is a sprayed acrylic glue.

A press 32 may be utilized to apply force to the superabrasive particles 28 in order to dispose the superabrasive particles into the spacer layer 22 as shown in FIG. 2. The press may be constructed of any material know to one skilled in the art able to apply force to the superabrasive particles. Examples include, without limitation, metals, wood, plastic, rubber, polymers, glass, composites, ceramics, and combinations thereof. Depending on the application, softer materials may provide a benefit over harder materials. For example, if unequal sizes of superabrasive particles are used, a hard press may only push the largest superabrasive particles through the spacer layer to the working surface 24. In one aspect of the present invention, the press is constructed of a porous rubber. A press constructed from a softer material such as a soft rubber, may conform slightly to the shape of the superabrasive grit, and thus more effectively push smaller as well as larger superabrasive particles through the spacer layer to the working surface.

The spacer layer may be made from any soft, deformable material with a relatively uniform thickness. Examples of useful materials include, but are not limited to, rubbers, plastics, waxes, graphites, clays, tapes, grafoils, metals, powders, and combinations thereof. In one aspect, the spacer layer may be a rolled sheet comprising a metal or other powder and a binder. For example, the metal may be a stainless steel powder and a polyethylene glycol binder. Various binders can be utilized, which are well known to those skilled in the art, such as, but not limited to, a polyvinyl alcohol (PVA), a polyvinyl butyral (PVB), a polyethylene glycol (PEG), a pariffin, a phenolic resin, a wax emulsions, an acrylic resin, and combinations thereof.

In another aspect, shown in FIG. 4, the superabrasive particles 28 may be disposed along the working surface 24 of the temporary substrate 26. An adhesive may be optionally applied to the working surface to hold the superabrasive particles essentially immobile along the temporary substrate. A spacer layer 22 may then be applied to the working surface such that the superabrasive particles become disposed therein, as shown in FIG. 2. A press 32 may be utilized to more effectively associate the spacer layer with the working surface and the superabrasive particles.

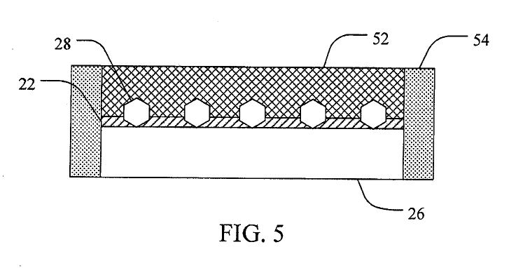

Referring now to FIG. 5, an at least partially uncured resin material 52 may be applied to the spacer layer 22 opposite the working surface 24 of the temporary substrate 26. A mold 54 may be utilized to contain the uncured resin material during manufacture. Upon curing the resin material, a resin layer is formed, bonding at least a portion of each superabrasive particles. A permanent substrate may be coupled to the resin layer to facilitate its use in dressing a CMP pad. In one aspect, the permanent substrate may be coupled to the resin layer by means of an appropriate fixative. The coupling may be facilitated by roughing the contact surfaces between the permanent substrate and the resin layer. In another aspect, the permanent substrate may be associated with the resin material, and thus become coupled to the resin layer as a result of curing. The mold and the temporary substrate can subsequently be removed from the CMP pad dresser.

The spacer layer can then be removed from the resin layer. This may be accomplished by peeling, grinding, sandblasting, scraping, rubbing, abrasion, or any other process known to one skilled in the art. The distance of the protrusion of the superabrasive grit from the resin layer will be approximately equal to the thickness of the now removed spacer layer. The resin layer may be acid etched to further expose the superabrasive grit.

One distinction between the various methods of disposing superabrasive particles into the spacer layer may be seen upon removal of the spacer layer. In those aspects where the superabrasive particles are pressed into the spacer layer, the spacer layer material in close proximity to a superabrasive particle will be deflected slightly towards the working surface of the temporary substrate. In other words, the spacer layer material surrounding an individual superabrasive particle may be slightly concave on the side opposite of the working surface due to the superabrasive particle being pushed into the spacer layer. This concave depression will be filled with resin material during the manufacture of the dresser, and thus the resin material will wick up the sides of the superabrasive particle once the resin layer is cured. For those aspects where the spacer layer is pressed onto the superabrasive particle, the opposite is true. In these cases, the spacer layer material in close proximity to a superabrasive particle will be deflected slightly away from the working surface of the temporary substrate. In other words, the spacer layer material surrounding an individual superabrasive particle may be slightly convex on the side opposite of the working surface due to the spacer layer being forced around the superabrasive particle. This convex protrusion may cause a slight concave depression in the resin layer surrounding each superabrasive particle. This slight concave depression may decrease retention, resulting in premature superabrasive particle pullout from the resin layer. For these aspects, various means of improving retention may be employed by one skilled in the art. For example, the spacer layer may be heated to reduce the slightly convex protrusion of the spacer layer surrounding a superabrasive particle prior to curing the resin layer. Also, additional resin material may be applied to the slight concave depression in the resin layer surrounding the superabrasive particle.

The temporary substrate may be made of any material capable of supporting the resin layer and withstanding the force of the press as described herein. Example materials include glasses, metals, woods, ceramics, polymers, rubbers, plastics, etc. The temporary substrate has a working surface upon which the spacer layer is applied. The working surface can be level, sloped, flat, curved, or any other shape that would be useful in the manufacture of a CMP pad dresser. The working surface may be roughened to improve the orientation of the superabrasive particles. When a superabrasive particle is pressed onto a very smooth temporary substrate, it may be more likely that a flat surface of the superabrasive particle will align parallel to the temporary substrate. In this situation, when the spacer layer is removed the flat surface of the superabrasive particle will protrude from the resin layer. Roughening the surface of the temporary substrate will create pits and valleys that may help to align the superabrasive particles such that the tips of individual superabrasive particle will protrude from the resin layer.

The following examples present various methods for making the coated superabrasive particles and tools of the present invention. Such examples are illustrative only, and no limitation on present invention is meant thereby.

### EXAMPLES

### Example 1

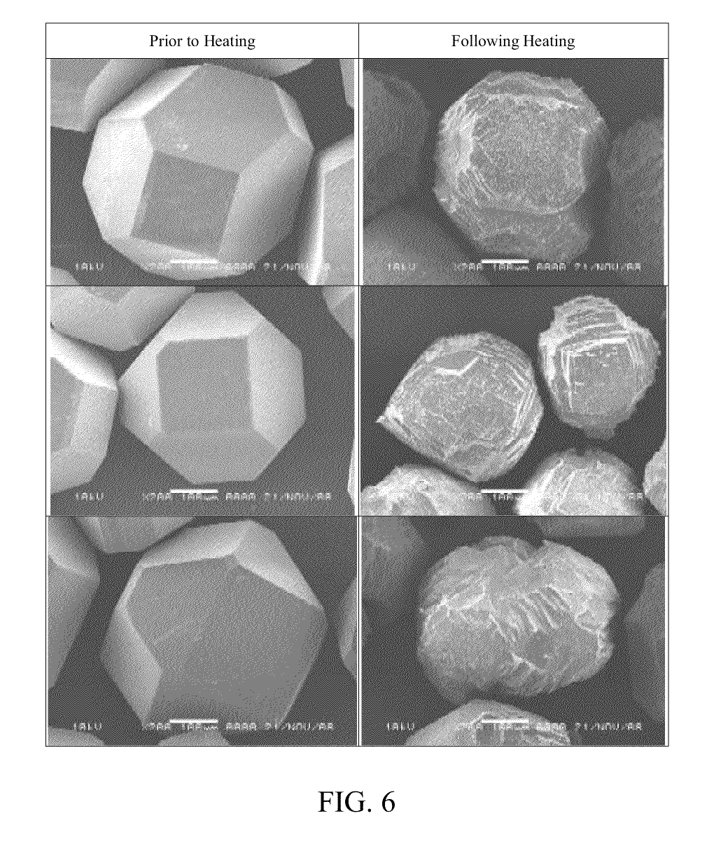

Diamond crystals of 40/50 mesh are heated in air to a temperature of 924° C. for 10 minutes. Subsequently, the furnace is cooled by turning off the electricity. FIG. 6 is a collection of SEM micrographs of diamond particles before heating and after heating showing roughening of the diamond surfaces.

### Example 2

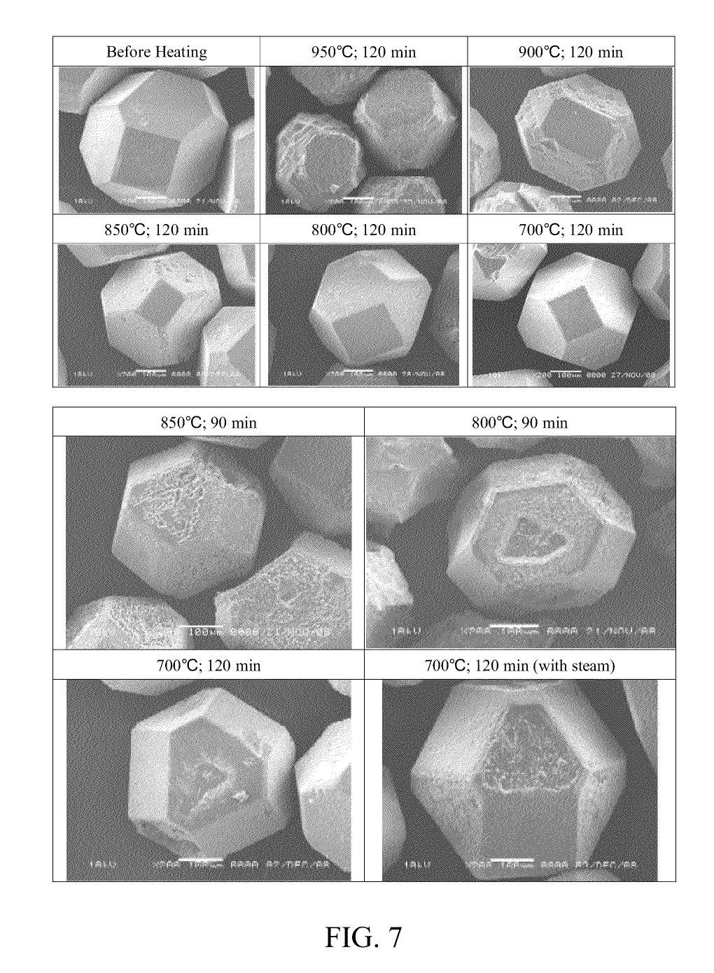

Diamond crystals are heated as in Example 1 in an atmosphere of pure oxygen. FIG. 7 is a collection of SEM micrographs of diamond particles before heating and after heating at various temperatures showing roughening of the diamond surfaces.

### Example 3

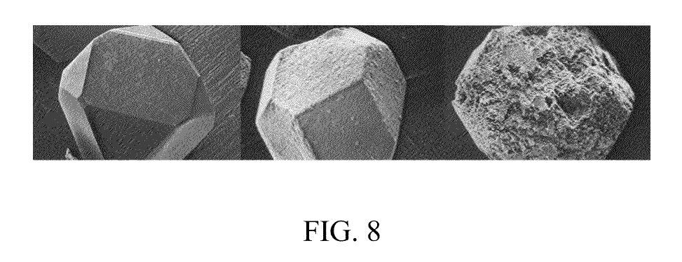

Diamond crystals of 40/50 mesh are packed in nickel powder and heated to different temperatures for about 10 minutes each. FIG. 8 shows SEM micrographs of diamond particle surfaces showing the degree of surface etching. The first diamond in the left panel was heated to about 700° C., the diamond in the middle was heat treated to about 900° C., and the diamond in the right panel was heated to about 1100° C.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A superabrasive tool, comprising:
a matrix layer; and
a plurality of superabrasive particles held in and protruding from the matrix layer,
whereby surfaces of the plurality of superabrasive particles contacting the matrix layer have been roughened to have an RA of greater than about 1 micron.

2. The superabrasive tool of claim 1, wherein the roughened surfaces of the plurality of diamond particles have an RA of from about 2 microns to about 10 microns.

3. The superabrasive tool of claim 1, wherein the roughened surfaces improve the retention of the plurality of superabrasive particles in the matrix layer.

4. The superabrasive tool of claim 1, wherein the matrix layer is a resin layer.

5. The superabrasive tool of claim 4, wherein the resin layer comprises a member selected from the group consisting of amino resins, acrylate resins, alkyd resins, polyester resins, reactive urethane resins, phenolic resins, phenolic/latex resins, epoxy resins, isocyanate resins, isocyanurate resins, polysiloxane resins, reactive vinyl resins, polyethylene resins, polypropylene resins, polystyrene resins, phenoxy resins, perylene resins, polysulfone resins, acrylonitrile-butadiene-styrene resins, acrylic resins, polycarbonate resins, polyimide resins, and mixtures thereof.

6. The superabrasive tool of claim 5, wherein the resin layer is an epoxy resin.

7. The superabrasive tool claim 5, wherein the resin layer is a polycarbonate resin.

8. The superabrasive tool of claim 5, wherein the resin layer is a polyimide resin.

9. The superabrasive tool of claim 1, wherein the plurality of superabrasive particles is a member selected from the group consisting of diamond, cubic boron nitride, silicon carbide, and combinations thereof.

10. The superabrasive tool of claim 1, wherein the superabrasive tool is a CMP pad dresser.

11. A method of making a superabrasive tool having improved superabrasive particle retention, comprising:
roughening surfaces of a plurality of superabrasive particles to an RA of greater than about 1 micron;
disposing the plurality of superabrasive particles in a matrix precursor; and
solidifying the matrix precursor into a matrix layer such that the plurality of superabrasive particles are held in and protrude from the matrix layer, whereby the roughened surfaces of the plurality of superabrasive particles improves retention of the plurality of superabrasive particles in the matrix layer as compared to retention of a superabrasive particle prior to roughening.

12. The method of claim 11, wherein roughening the surfaces further includes oxidizing the surfaces.

13. The method of claim 11, wherein roughening the surfaces further includes etching the surfaces.

14. The method of claim 11, wherein the plurality of superabrasive particles is a member selected from the group consisting of diamond, cubic boron nitride, silicon carbide, and combinations thereof.

15. The method of claim 11, wherein the plurality of superabrasive particles is diamond.

16. The method of claim 15, wherein roughening the surfaces further includes depositing diamond material on surfaces of the plurality of superabrasive particles.

17. The method of claim 11, wherein the plurality of superabrasive particles is arranged in the matrix layer according to a predetermined pattern.

18. The method of claim 11, wherein disposing the plurality of superabrasive particles in the matrix precursor and solidifying the matrix precursor into the matrix layer further includes:
providing a temporary substrate having a working surface;
applying a spacer layer to the working surface of the temporary substrate;
disposing the plurality of superabrasive particles at least partially into the spacer layer, where the plurality of superabrasive particles protrude at least partially from the spacer layer opposite the working surface of the temporary substrate;
applying the matrix precursor to the spacer layer opposite the working surface of the temporary substrate;
solidifying the matrix precursor into the matrix layer;
removing the temporary substrate from the spacer layer; and
removing the spacer layer from the matrix layer.

19. The method of claim 18, wherein applying a spacer layer further includes:
applying the spacer layer to the working surface of the temporary substrate; and
pressing the plurality of superabrasive particles into the spacer layer.

20. The method of claim 18, wherein applying a spacer layer further includes:
disposing the plurality of superabrasive particles along the working surface of the temporary substrate; and
pressing the spacer layer onto the plurality of superabrasive particles such that the superabrasive particles are disposed at least partially within the spacer layer.
